(19) United States
(12) Patent Application Publication
(10) Pub. No.: US 2010/0250362 A1
(43) Pub. Date: Sep. 30, 2010

(54) System and Method for an Online Advertising Exchange with Submarkets Formed by Portfolio Optimization

(76) Inventors: Eric Theodore Bax, Altadena, CA (US); Krishna Prasad Chitrapura, Bangalore (IN); Sachin Garg, Bangalore (IN); Darshan Kantak, Pasadena, CA (US); Anand Kuratti, Bangalore (IN); Joaquin Arturo Delgado Rodriguez, Santa Clara, CA (US)

Correspondence Address: STATTLER - SUH PC, 60 SOUTH MARKET STREET, SUITE 480, SAN JOSE, CA, 95113, US

(21) Appl. No.: 12/415,846

(22) Filed: Mar. 31, 2009

(51) Int. Cl. G06Q 30/00; G06N 5/02

(52) U.S. Cl. 705/14.43; 705/10; 705/26; 706/52; 705/14.46

(57) ABSTRACT

A system and method to distribute computation for an exchange in which advertisers buy online advertising space from publishers. The exchange maintains submarkets, each containing a subset of the ad calls supplied by publishers and a subset of the offers and budgets representing demand from advertisers. Portfolio optimization techniques allocate the supply of ad calls from publishers over the submarkets, with the goal of maximizing profits for publishers while limiting the volatility of those profits. Portfolio optimization techniques allocate the demand from advertisers over the submarkets, with the goal of maximizing return on investment for advertisers. The exchange re-allocates supply and demand over submarkets periodically. Also, periodically, the most effective submarkets are replicated and the least effective submarkets are eliminated.

### FIELD OF THE INVENTION

The present invention is directed towards an exchange in which publishers sell and advertisers buy ad space in online content.

### BACKGROUND OF THE INVENTION

An exchange for online advertising allows advertisers or their representatives to purchase placement of ads on ad slots in views of online content, which are called impressions. Publishers of online content send ad calls (i.e. an opportunity to display an impression) to the exchange. Each ad call represents a request for ad offers (i.e. advertiser bids) to purchase the right to place an ad in an ad slot on an impression. An ad call may include data about the publisher issuing it, the online content that is the context of the ad slot, and the user who will experience the impression.

The exchange hosts ad offers for advertisers. Each offer has a budget that expresses how much money it can spend and at what rate it can spend. An offer includes bidding rules to determine whether and how much to bid for an ad call and which ad to show if the exchange accepts the bid. Inputs for the rules to determine how much to bid may include the budget for the offer, how much of the budget has been spent, and information about the ad call such as the publisher, the content surrounding the ad slot being sold, the internet address of the web page containing the ad slot, and demographic and geographic data about the user who will experience the ad.

For each ad call, the exchange identifies a set of candidate offers through a process called matching. For each candidate offer, the exchange uses the offer's bidding rules to generate a bid or a refusal to bid. This process is called bid generation. The exchange selects a winning bid from the generated bids. This process is called bid selection. The exchange then awards the ad slot to the ad specified by the offer that generated the winning bid.

Bid selection may be more complex than simply choosing the highest bid, because bids may have different price types. Some common price types are CPM (cost per mille, or thousand impressions), CPC (cost per click), and CPA (cost per action). A bid with a CPM price type pays per ad placement. A CPC bid pays only if the ad placement leads to a user clicking on the ad. A CPA bid pays only if the ad placement leads to an advertiser-specified result, called an action or conversion. The exchange can compare bids with different price types on the basis of expected values. For a CPM bid, the expected value is the bid itself. For CPC and CPA bids, the expected value is the bid times the probability of the response that triggers payment—a click for CPC or an action for CPA. So the exchange needs to estimate probabilities of response in order to perform bid selection. Estimating these probabilities is called response prediction.

An exchange for online advertising can have a simple distribution model, for example a model in which every server hosts every offer and the budget for each offer is partitioned over all servers. Each ad call is sent to a single server, and that server performs matching, offer evaluation, and selection. This method has the characteristic that every possible offer is available to each ad call. The method works for small to medium numbers of offers and servers, making it a sensible way to get started.

However, market growth brings more servers and more offers. With more servers, offer budgets are partitioned into smaller and smaller portions, so each ad call becomes more and more likely to arrive at a server where the best offer for the ad call has spent its budget on that server, but plenty of budget for the offer remains on other servers. With more offers, less and less data can be stored in each server for each offer, forcing the system to use simpler models for response prediction and simpler bidding rules, resulting in selection of ads for ad calls that offers less revenue for publishers and lower return on investment for advertisers. So there is a need for an online ad exchange that can maintain effective ad selection as the numbers of servers and offers increase.

### SUMMARY OF THE INVENTION

A system, method, and computer program product to distribute computation while maintaining effective ad selection for an exchange in which advertisers buy online advertising space from publishers. The exchange maintains submarkets, each containing a subset of the ad calls supplied by publishers and a subset of the offers and budgets representing demand from advertisers. Portfolio optimization techniques are used to allocate the supply of ad calls from publishers over the submarkets, with the goal of maximizing profits for publishers while limiting the volatility of those profits. Portfolio optimization techniques are also used to allocate the demand from advertisers over the submarkets, with the goal of maximizing return on investment for advertisers. Periodic reallocations of supply and demand over submarkets cause the submarkets to evolve over time. Also, periodically, the most effective submarkets are replicated and the least effective submarkets are eliminated.

### BRIEF DESCRIPTION OF THE DRAWINGS

A brief description of the drawings follows:

FIG. 1 shows data flows for an ad selection procedure in an exchange with submarkets, according to some embodiments.

FIG. 2 shows data flows for allocating supply and demand over submarkets. Data flows for the ad selection procedure are shown with dotted lines. Data flows for allocations are shown with solid lines, according to some embodiments.

FIG. 3 shows data flows for allocating ad calls over submarkets for a publisher, according to some embodiments.

FIG. 4 shows data flows for allocating budget over submarkets for an advertiser offer, according to some embodiments.

FIG. 5 is a diagrammatic representation of a machine in the exemplary form of a computer system, within which a set of instructions may be executed, according to one embodiment.

FIG. 6 is a diagrammatic representation of several computer systems in the exemplary form of a client server network, within which environment a communication protocol may be executed, according to one embodiment.

### DETAILED DESCRIPTION

In the following description, numerous details are set forth for purpose of explanation. However, one of ordinary skill in the art will realize that the invention may be practiced without the use of these specific details. In other instances, well-known structures and devices are shown in block diagram form in order to not obscure the description of the invention with unnecessary detail.

As indicated, there is a need for embodiments of an online ad exchange that can maintain effective ad selection as the numbers of servers and offers increase. Using submarkets based on portfolio optimization is one technique to partition computing load and data. Using one or more of the herein-described portfolio optimization technique may result in partitions with desirable characteristics. Some of the desired characteristics are introduced in the following paragraphs.

### Scaling in Servers

Budgets need not be partitioned more and more as the number of servers grows. A small, specialized submarket can be hosted on one server, hosting all offer budget allocated to the submarket so that fewer ad calls miss out on opportunities due to server-level budget exhaustion. Large, unspecialized submarkets where budget splitting is less of an issue and bandwidth is more important can still be hosted across many servers.

### Scaling in Offers

With each offer on only a portion of the servers, it is easy to increase the number of offers. Specialized offers can be located only in submarkets that receive the ad calls that meet the targeting requirements in their bidding rules. Offers with bidding rules that allow competitive bids on more general sets of ad calls and that have small or medium budgets can take part in a few submarkets and hence reside on several servers. Offers with very large budgets and competitive bids on a wide variety of ad calls can reside in many servers to ensure that they receive full delivery.

### Richer Response Prediction

With a limited number of offers per server, servers can support much more data per offer. So response prediction can use more complex models, with more features and more ways of combining them. Also, response prediction can use different models for different offers. For each offer, the system can initially determine which features carry the most information about responses. Then the system can fit a model to the selected features to predict responses. For example, the system may find that gender and age are the important factors for one offer while hour of day combined with geographic location are the important factors for another.

### Richer Bidding Rules

As with response prediction, having a limited number of offers on each server allows richer bidding rules for each offer because it allows more of the server's storage and computation to be applied to each offer. Richer bidding behavior can include using specialized third-party data to determine how much to bid for each ad call, complex spend management techniques to more efficiently pace the spending of offer budgets over time, and balancing buying over categories of impressions.

### Supports Variety in Matching Technologies

Different submarkets can use different matching techniques. For some submarkets, it will be important to quickly identify a few offers among many and then perform deeper analysis to select the candidate offers. For other submarkets with fewer offers, it may be more profitable to investigate the value of each offer in more depth for each ad call. Supporting variety in matching technologies allows different servers to use different parameter values in order to tune techniques, and it allows experiments on a few servers to explore new techniques.

Some embodiments of the invention place each offer on a subset of the submarkets in the exchange, and it routes each ad call to a subset of the submarkets. For each ad call, submarkets identify candidate offers, and a winning offer is selected from the candidates. The exchange:
Periodically adjusts the allocation of traffic over the submarkets for each publisher who supplies online content and ad calls, with a goal of increasing revenue for the publisher while respecting any publisher-specified restrictions on risk of returns.
Periodically adjusts the allocation of offers and budgets over the submarkets for each advertiser, with a goal of increasing return on investment for the advertiser while respecting any advertiser-specified restrictions on risk of returns.
Periodically adjusts the mixture of submarkets of servers, replicating and removing unsuccessful ones. Success metrics may be based on factors including publisher revenue, advertiser spending, and exchange return on investment based on cost of operation and volume and financial return of business.

The periodic adjustments cause the set of submarkets to evolve over time in response to market forces. If a submarket offers great value for some publishers, then over time allocations shift more supply to it, in the form of ad calls. If a submarket offers great value for some advertisers, then over time allocations for those advertisers those advertisers shift more demand to it, in the form of increased offers and budget for those offers. If a submarket consistently offers great value to some publishers, to some advertisers, and to the exchange, then the submarket is replicated. Then, through continuing allocations, the copies of the submarket may evolve differently to better serve different subsets of the publishers and advertisers.

The rest of this description is organized as follows: Section 1 describes how an exchange of submarkets handles ad calls and, in the process, collects data to feed the periodic allocation processes. Section 2 describes portfolio optimization. Section 3 focuses on how to use portfolio optimization to allocate ad calls over submarkets for publishers. Section 4 focuses on how to use portfolio optimization to allocate offers and budgets over submarkets for advertisers. Section 5 describes how to select lengths of time periods between allocations and how to handle submarket replications and removals in allocations.

### Section 1. Ad Selection Procedure and Data Collection

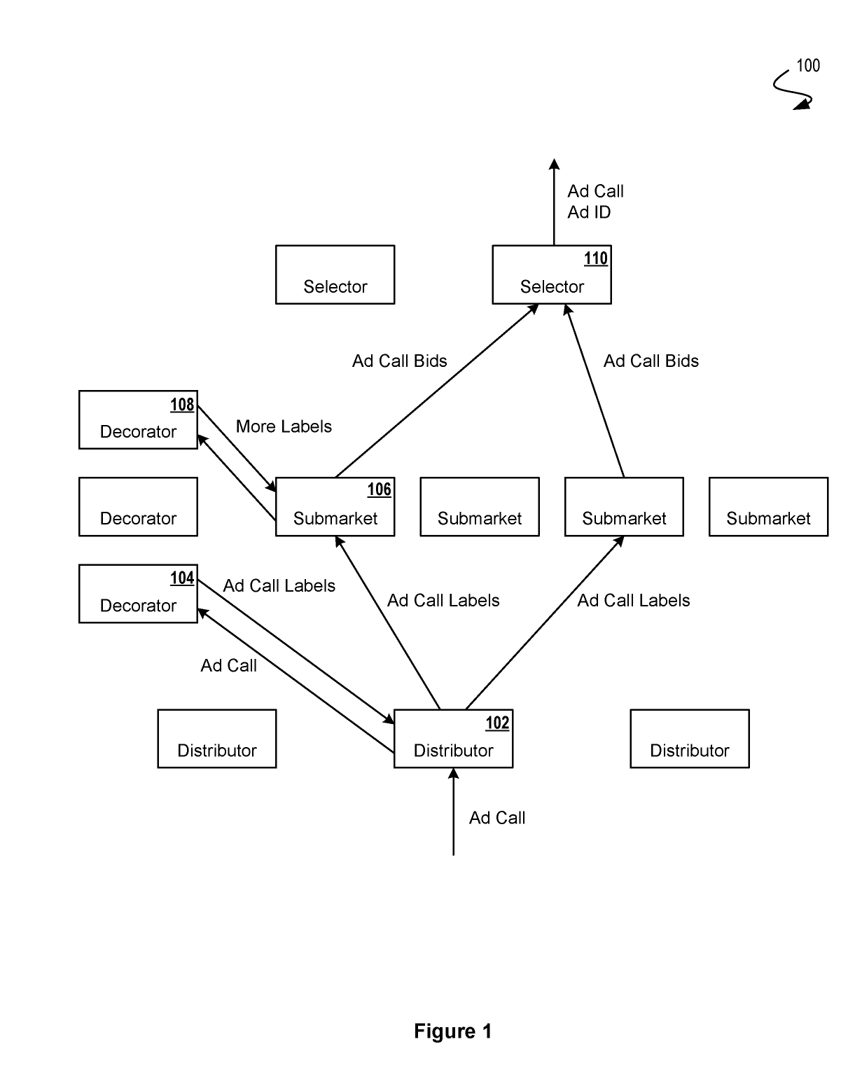

FIG. 1 shows the ad selection procedure in response to an ad call for an exchange of submarkets. The exchange 100 includes a variety of processes (e.g. selector, distributor, decorator, etc), each of which have associated computing resources and which are able to communicate with each other. An exchange may contain many instances of each type of process. Multiple processes may share servers, and individual processes or submarkets may be implemented on multiple servers.

As shown in FIG. 1, an ad call arrives at a distributor process (e.g. Distributor 102), which may send data on the ad call to one or more decorator processes (e.g. Decorator 104). A decorator processes may add information to the ad call, for example a decorator process may take a user id from an ad call, use the user id to look up demographic data about the user (e.g. age, gender, etc), and add that data to the ad call. The added data may be called labels, tags, or properties. As shown, the distributor process 102 sends the ad call and labels, if any, to one or more submarkets (e.g. Submarket 106). Each submarket may use one or more decorators to obtain additional data about the ad call. For example, the submarket 106 may decorator 108 to obtain additional data about the ad call. One or more submarkets perform matching and bid generation based on their offers. A selector process (e.g. Selector 110) gathers the bids and performs bid selection to determine a winning bid. The winning bid determines which ad to show. After the ad is shown, the exchange is notified of responses to the ad, including clicks and actions that may trigger payment for bids with CPC or CPA pricing.

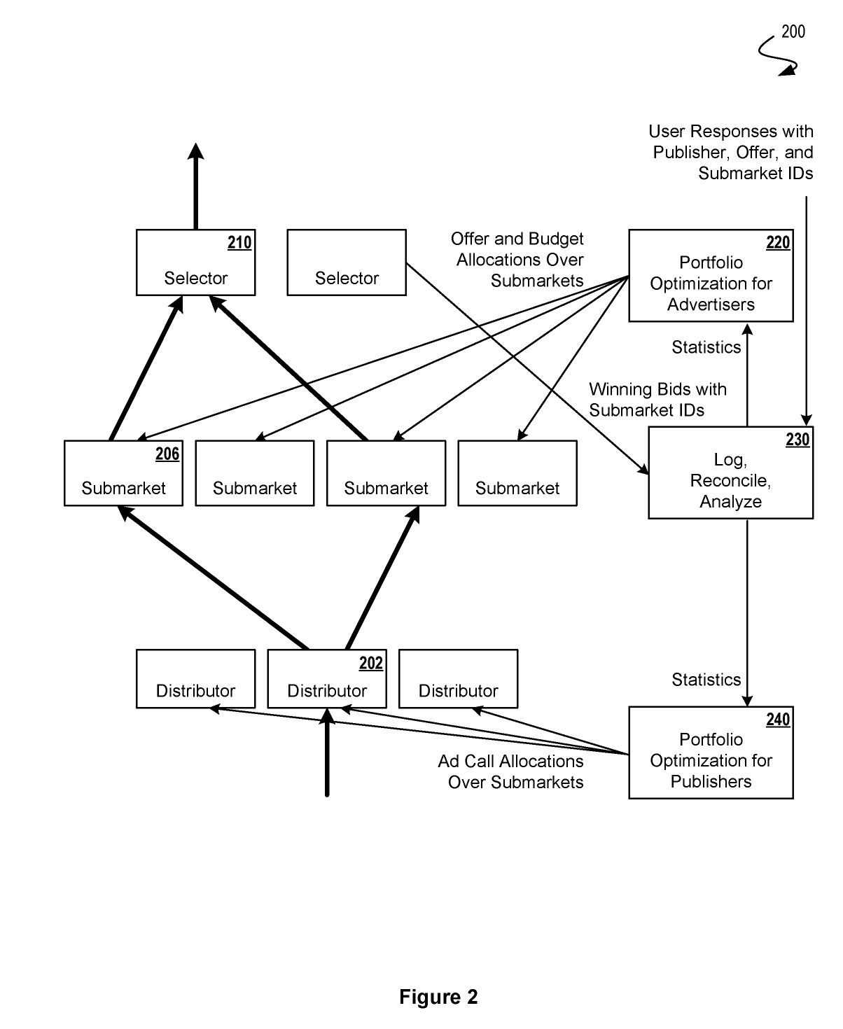

FIG. 2 shows how the exchange 200 collects data from the ad selection procedure and form responses to ads in order to supply inputs to procedures that allocate ad calls among submarkets for publishers and procedures that allocate offers and budgets over submarkets for advertisers. In FIG. 2, data collection and inputs and outputs for allocations are shown with thick solid lines; inputs and outputs for the ad selection procedures shown in thin solid lines. The exchange collects data on winning bids and user responses. By reconciling user responses with winning bids, the exchange computes values of winning bids with CPC and CPA price types by determining whether clicks or actions that trigger payment have occurred. By collecting additional data, the exchange can develop statistics on revenue by submarket, offer, and publisher to feed allocation procedures. For example, one way to collect the additional data is to add to data on the winning bid, the submarket and offer that produced the winning bid, and the publisher that submitted the ad call that prompted the bid.

### Section 2. Portfolio Optimization

The goal of classical portfolio optimization is to allocate resources among investments to maximize expected returns given an expressed tolerance for risk. Classical portfolio optimization assumes a set of investments with known expected returns, variances of returns, and correlations among returns. Let rᵢ be the expected return from investment i. Let σᵢ be the standard deviation of returns from investment i. Let ρᵢⱼ be the correlation between returns on investments i and j.

For an investment portfolio w, let wᵢ be the fraction of the resources allocated to investment i. Then

$${\sum }_{i} {w}_{i} = 1 , \\ and$$

$$∀ i \text{:} {w}_{i} \geq 0.$$

The expected return for the portfolio is

$${r}_{p} = {\sum }_{i} {w}_{i} {r}_{i} .$$

The variance of return for the portfolio is

$${σ}_{p}^{2} = {\sum }_{i} {\sum }_{j} {w}_{i} {w}_{j} {σ}_{i} {σ}_{j} {ρ}_{ij} ,$$

where ρᵢⱼ=1 for i=j. The volatility of the portfolio is defined as

σₚ=\sqrt{ρₚ²}.

To find the portfolio that maximizes expected return given a risk tolerance specified by

qε[0,∞),

solve the quadratic optimization problem:

$${w}^{*} = argmin \frac{1}{2} {w}^{T} \sum w + {qr}^{T} w$$

subject to the constraints

$${\sum }_{i} {w}_{i} = 1$$

$$and$$

$$∀ i \text{:} {w}_{i} \geq 0.$$

As discussed herein, this problem is termed the basic portfolio optimization problem. There are many commercially available solvers for this problem and for the general class of quadratic optimization problems to which this problem belongs, namely quadratic optimization problems with symmetric matrices in their quadratic objective functions and linear constraints.

Each entry wᵢ* is the fraction of resources to invest in investment i. If the risk tolerance is specified in terms of portfolio volatility instead of a value of q, then solve for a range of q values, identify those with solutions w* having volatility close to the goal, solve for ranges of q values close to those that gave nearly the desired volatility, and repeat until the desired accuracy is achieved.

### Section 3. Allocating Ad Calls Over Submarkets for Publishers

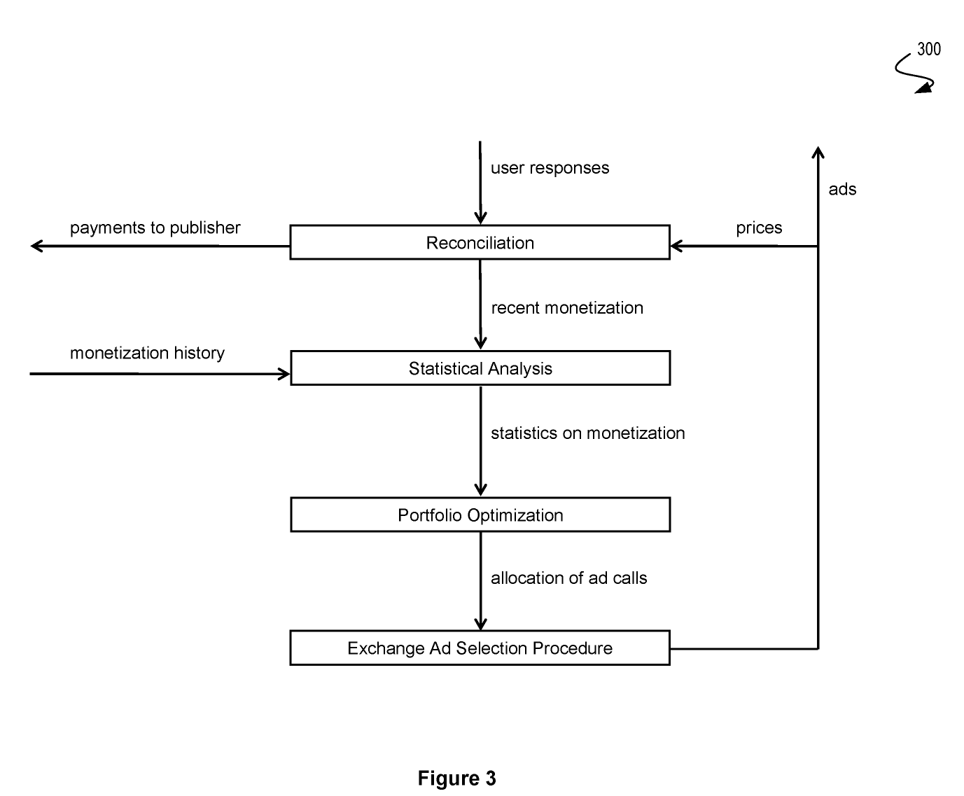

FIG. 3 shows data flows for the process of allocating ad calls over submarkets for a publisher. Following the terminology of the basic portfolio optimization problem as described above, for publishers, the resource to invest is a set of ad calls. Submarkets are investments. The return on investment is the amount the exchange pays the publisher, based on the offers selected by the submarket.

So, for each publisher, prior to each time period, various embodiments optimize the allocation of the publisher's ad calls over submarkets for the time period as follows. Let rᵢ be the expected amount the exchange pays the publisher if all the publisher's ad calls for the time period are sent to submarket i. Let σᵢ be the standard deviation of the amount the exchange pays the publisher if all the ad calls are sent to submarket i. Let ρᵢⱼ be the correlation between these amounts for submarkets i and j, and define ρᵢᵢ to be one for all submarkets i. Given those inputs, solve the basic portfolio optimization problem. Each entry wᵢ* in the solution is the fraction of ad calls to send to submarket i.

### Gathering Inputs

Solving for an optimal portfolio includes quantification of expected returns, standard deviations, and correlations or estimates of those statistics. In traditional portfolio optimization, historical records of return supply estimates for those statistics. Thus, when there is a history of the publisher using a submarket to monetize ad calls, the historical data might be used to supply statistics. Otherwise, one option is to use statistics over publishers with similar ad calls, for example, when optimizing for a set of ad calls on pages with “sports content”, use historical returns over other ad calls on pages with “sports content” (i.e. second-hand data) to generate statistics for returns, standard deviations, and correlations. For cases where even second-hand data is non-existent or inaccessible, embodiments might use statistics based on the history of similar ad calls across new submarkets in general.

In addition to statistics, solving for an optimal portfolio includes a specified risk tolerance. The exchange can give publishers a mechanism to express risk tolerance. Then the exchange can convert the expressed tolerance to a volatility tolerance or value of q.

### Extensions

For each publisher, the exchange may solve the portfolio optimization problem over a subset of the submarkets. A subset of submarkets may be selected to participate in the optimization for a publisher based on the amount and type of data available to indicate how much revenue the submarkets will generate for the publisher's ad calls. For a new publisher, the exchange can use data from other publishers to select an initial set of submarkets. As the publisher's ad calls are sent to submarkets, the exchange collects data specific to the publisher. As more of that data becomes available, the exchange may begin to impose a higher standard on the characteristics of the data used to determine whether or not to include a particular submarket in the portfolio optimization procedure.

In addition to submarkets, the portfolio optimization procedure can treat strategies to select a submarket for an ad call as investments. For example, an “exploration” strategy may be to select a submarket at random from a distribution for an ad call. Ad calls allocated to this strategy can produce data on the publisher's returns over some submarkets not directly considered in the optimization, so that those submarkets may be considered directly in the future. Exploration strategies may be based on collaborative filtering, with submarkets to be explored selected from submarkets that are effective for similar publishers.

The exchange may partition the ad calls from a publisher into an exploration budget and an exploitation budget, using portfolio optimization to create separate allocations for exploration and exploitation. The fraction of ad calls devoted to exploration may be based on a combination of preference expressed by the publisher and on the estimated net present values of exploration and exploitation, comparing the estimated probability of discovering better submarkets through exploration to the relative certainty of returns from submarkets with a known history of returns for the publisher.

If a publisher has many and diverse ad calls, the exchange can partition the ad calls, treating each subset of the ad calls as a separate publisher and performing a separate portfolio allocation for it. If the publisher has multiple websites and web pages, the ad calls may be partitioned by website or page. The ad calls may also be partitioned based on demographic or geographic data about the user who will view the selected ad. Likewise, the exchange may combine ad calls from similar small publishers, performing a single portfolio allocation for the group of publishers.

Instead of issuing an ad call to a single submarket, the exchange may issue the ad call to multiple submarkets and then select among the offers identified by the submarkets. The set of submarkets can be treated as a single investment in the portfolio optimization procedure. In the optimization procedure, the exchange may subtract a penalty from the publisher's return on the strategy to account for the potential effect on the exchange's bandwidth and latency from using multiple submarkets for a single ad call.

### Section 4. Allocating Offers and Budgets Over Submarkets for Advertisers

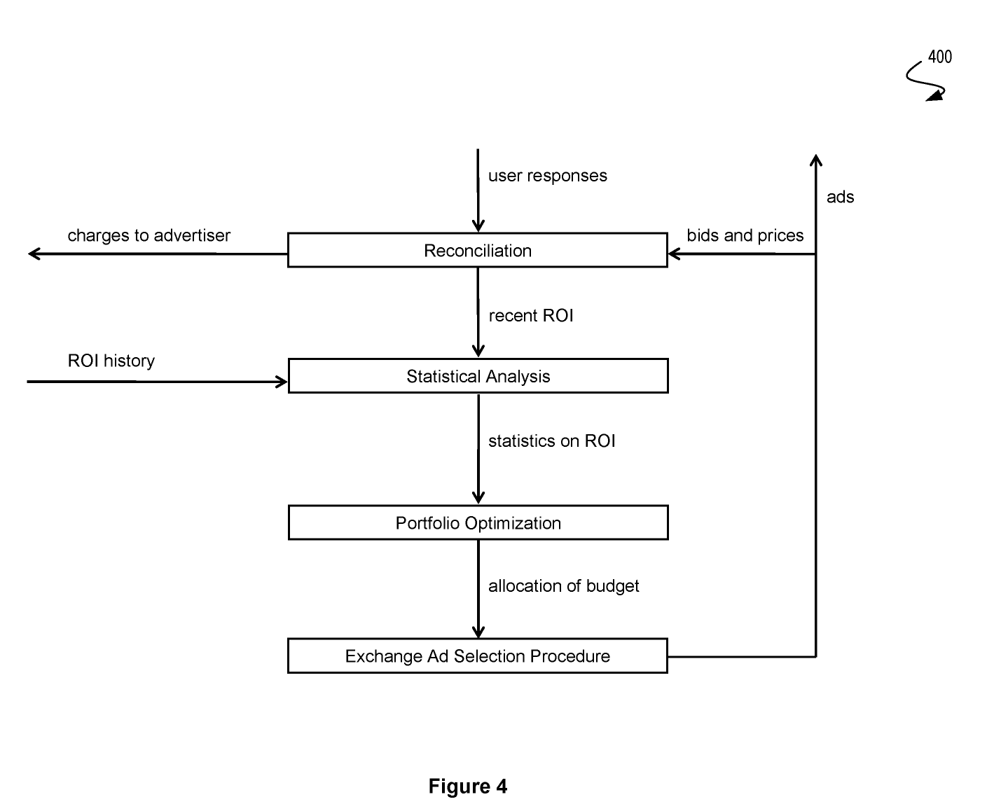

FIG. 4 shows data flows for the process of allocating budget over submarkets for an advertiser offer. Following the terminology of the basic portfolio optimization problem as described above, for advertisers, the resource is budget for an offer. Submarkets are investments. The return on investment (ROI) is the financial return for the advertiser, based on the submarket utilizing budget for the offer to place ads on ad calls.

So, for each offer, prior to each time period, some embodiments optimize the allocation of the offer budget over submarkets for the time period as follows. Let rᵢ be the expected ROI for the offer if all the offer budget for the time period is allocated to submarket i. Let σᵢ be the standard deviation of the ROI if the offer's whole budget is allocated to submarket i. Let ρᵢⱼ be the correlation between these amounts for submarkets i and j, and define ρᵢᵢ to be one for all submarkets i. Then solve the basic portfolio optimization problem. Each entry wᵢ* in the solution is the fraction of offer budget to allocate to submarket i.

### Gathering Inputs

Solving the basic portfolio optimization problem uses statistics on ROI for the offer over some submarkets and information about risk tolerance. Of course, techniques similar to those outlined for publishers might be used to gather statistics for each offer or to estimate statistics based on data for similar offers if the offer is new to a submarket or the exchange. Similarly, some embodiments use the techniques outlined for publishers to gather risk tolerance input for advertisers.

There are different techniques to compute or estimate advertiser ROI, depending on the information available to the exchange and the price type for the offer. Some price types include CPM, which means the advertiser pays for each time the offer's ad is shown, and CPA, which means they pay only if some action follows from the ad being shown. When the action that triggers payment is a sale, the action is often called a conversion. When the trigger action is a click on the ad, the price type is called pay per click or CPC. CPM can be seen as a trivial form of CPA, where the action is simply ad placement.

Advertiser ROI is the value to the advertiser produced by showing an ad minus the cost to the advertiser of placing the ad. The paragraphs to follow discuss possibilities for quantifying value, and possibilities for quantifying cost.

### Value

When advertisers are focused on performance—on making sales—then advertisers can report to the exchange estimates of values for sales that result from ad placements on different submarkets. When advertisers do not share this information with the exchange, then the advertiser value can be estimated by counting actions for each submarket and estimating a value per action for the advertiser based on their bid. This technique does not require extra effort or data from the advertiser, since actions already need to be counted to bill advertisers, where the action is ad placement for CPM, clicks for CPC, and advertiser-defined actions for CPA. As advertisers become more willing to supply value information beyond what is needed for billing, the exchange can use advertisers' value information to improve outcomes for the advertisers. For example, if an offer has a CPM price type, and the advertiser is willing to supply the exchange with data about which ad placements result in sales, the exchange can use that data to better estimate advertiser value obtained from different submarkets.

When advertisers are focused on brand—on building awareness and relationships—then advertisers can report to the exchange their estimates of values of ad placements or other actions. These estimates may be based on metrics like reach and frequency. Reach is the number of people who experience an ad, and frequency is how many times they experience it. The exchange can measure the contributions to reach and frequency from ad placements on different submarkets and combine this with advertiser-expressed preferences on reach and frequency to estimate the value of ad placements made by different submarkets. Without this data, the exchange can simply use bid as a proxy for value. Note that bid need not be equal to amount paid; in a second-price auction these numbers are usually different.

### Cost

The cost of placing the ad can be computed by the exchange. For CPM ads, the cost can be computed directly from the prices generated by the ad selection procedure on the exchange. For other price types, in which advertisers pay a price only if a user responds to the ad placement, information about prices can be combined with information about user responses to compute advertiser costs. The process of combining price and user response data to produce cost information is called reconciliation.

For CPC ads, the cost depends on the number of clicks, which can be collected from the ad server. For CPA ads for which the action occurs beyond the exchange and ad server, there may be a time delay in reporting actions back to the exchange, so the exchange may need to estimate the cost to generate data for statistics from recent time periods. The exchange may use its response prediction facilities for this purpose. For example, if a CPA offer pays $100 per action and the exchange's response prediction estimates there is one action per 400 ad placements, then the exchange can estimate that each ad placement will cost $0.25 on average.

### Extensions

It is possible for part of the offer budget allocated to a submarket for a time period to remain unspent at the end of the time period. To compensate for this under-spending, the exchange can allocate extra total budget for each time period. Tune the amount of over-budgeting to spend the intended budget by balancing overspending in some submarkets against under-spending in others.

For each submarket that has a consistent or predictable limit on the amount of budget it can consume for an offer in a time period, the exchange can impose the limit as an additional constraint in the portfolio optimization problem. Let b be the total budget for the offer for the time period. Let sᵢ be the estimated amount of budget that submarket i can consume for the offer in the time period. Add the constraint

wᵢb≦sᵢ

to the portfolio optimization problem. The optimization problem remains tractable with these added conditions, since it remains a quadratic optimization problem with the quadratic function based on a symmetric matrix and with linear constraints.

The exchange may manage a single budget for a campaign that includes multiple offers. In this case, the exchange can solve a single portfolio optimization problem for the campaign by treating each offer-submarket pair as a potential investment. The resulting portfolio allocates budget by offer and submarket.

In campaign-based optimization, there may be a need to balance spending over offers in response to advertiser preferences or as a way of ensuring that ROI data are gathered for a variety of offers. The exchange may add constraints to the portfolio optimization problem to enforce balanced spending. Let wᵢₖ be the budget allocated to offer k on submarket i. Let m be the number of offers in the campaign. For example, to ensure equal budgets for each offer, add the constraint

$$∀ k \text{:} {\sum }_{i} {w}_{ik} = \frac{1}{m} .$$

As another example, to ensure that no offer receives less than a fraction p of the budget, add the constraint

$$∀ k \text{:} { \sum }_{i} {w}_{ik} \geq p .$$

The portfolio optimization problem remains tractable after adding these linear constraints.

The portfolio optimization problem for each offer or campaign may involve a subset of the submarkets in the exchange. As with portfolio optimization for publishers, the submarkets may be selected based on available data and on advertiser preferences and exchange procedures to balance exploration against exploration. Also, the requirements for a submarket to be included in the portfolio optimization problem may evolve as the offer or campaign matures on the exchange.

The exchange may impose a penalty in the optimization for each submarket that hosts an offer. The penalties account for the opportunity cost of the submarket to host offers and hence not having resources to host some others. The penalties may also account for the potential increase in latency to select and place an ad due to hosting the offer. One way to implement the penalties is to first solve the portfolio optimization problem without penalties over a set of submarkets. Then subtract the penalties for the submarkets with nonzero budget allocations from the solution's value for the objective function. Remove the zero-budget submarkets from the problem. Remove the submarket with least budget among those still in the problem. Re-solve and subtract the penalties for the submarkets with nonzero budget allocations in the new solution from the new value of the objective function. Repeat until the objective function value, adjusted by penalties for submarket hosting, increases. Use the solution that produced the minimum adjusted objective function value as the portfolio allocation.

### Section 5. Time Periods, Submarket Replication and Removal, and Initial Submarket Allocations

The exchange can use different time periods to adjust allocations for different sets of ad calls, ads, and ad campaigns. Shorter time periods allow the exchange to react more quickly to changing market conditions. Longer time periods allow the exchange to gather more data per time period and to perform less computation per unit of time. Since it takes time to gather and analyze data, the statistics used as input to the portfolio optimization problems may not incorporate data for the most recent time periods.

To increase stability, the exchange may limit how much allocations may change from one time period to the next. To do this, the exchange can add some constraints to the portfolio optimization problem. For example, to ensure that the fraction of a resource allocated to any submarket does not change by more than A, add constraints

∀i: wᵢ(t+1)≦wᵢ(t)+Δ

and

∀i: wᵢ(t+1)≧wᵢ(t)−Δ,

where wᵢ(t) is the allocation wᵢ for time period t, and wᵢ(t+1) is the allocation for the next time period.

As successful submarkets are replicated and unsuccessful ones are removed, the exchange alters statistics and allocations to reflect the changes. When a submarket is replicated, the exchange can copy the historical statistics for the submarket and use them for all copies. The ad call allocations to the submarket can be partitioned evenly across the copies. The ads and ad offers hosted by the submarket can be replicated among the copies. The ad and ad offer budgets need not be partitioned evenly among the copies; introducing some variation allows the new submarkets to diverge and fill different niches in the marketplace. Of course, when a submarket is removed, it is reasonable to remove it from subsequent portfolio optimization problems. The ad call allocations to the submarket can be partitioned among the other submarkets in their portfolios. Likewise, the ad and ad offer budgets in the submarket can be partitioned among the other submarkets in their portfolios.

When starting to use submarkets, an exchange may not have data by submarkets to use as input to portfolio optimizations to allocate supply and demand over submarkets. One way to initialize the system is to begin with random allocations to form submarkets. It is also possible to use heuristics to form submarkets. For example, the exchange can cluster publishers and offers and place publishers and offers that are in the same clusters on the same submarkets. The clustering can be based on topic, for example news, sports, entertainment and so forth, with publishers and advertisers selecting topics of interest or being labeled by the exchange. Alternatively, the clustering can be based on publishers specifying advertisers of interest and vice versa or on which advertisers have been shown on which publishers in the past.

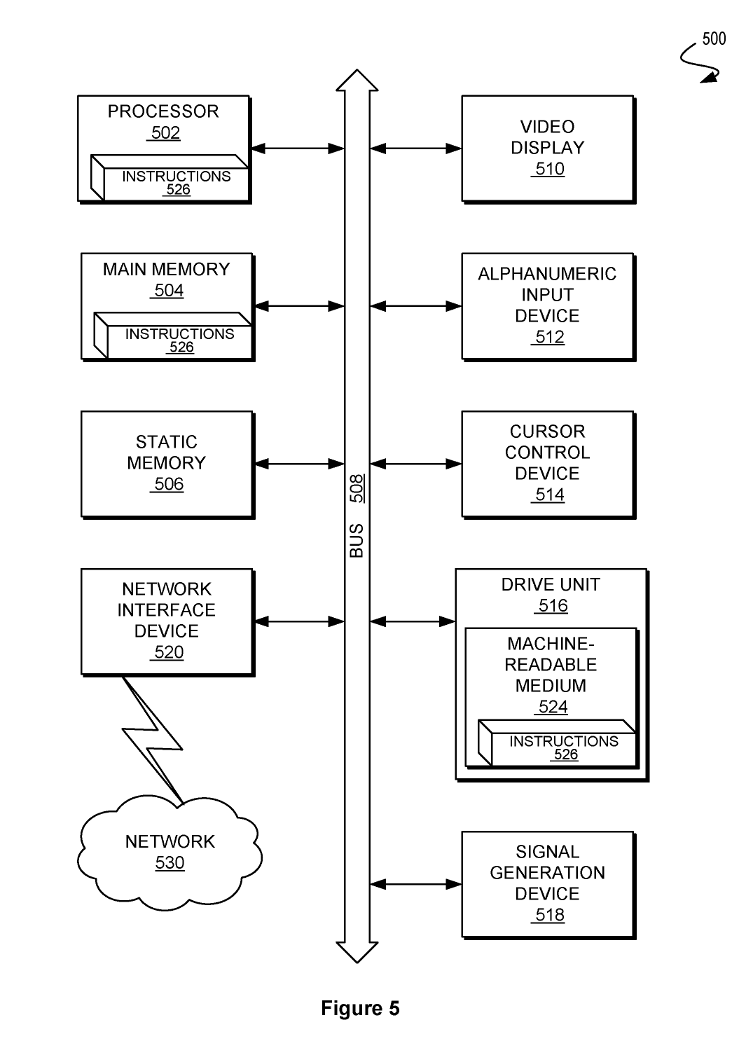

FIG. 5 is a diagrammatic representation of a machine in the exemplary form of a computer system 500, within which a set of instructions for causing the machine to perform any one of the methodologies discussed above may be executed. The embodiment shown is purely exemplary, and might be implemented in the context of one or more of FIG. 1A through FIG. 4. In alternative embodiments, the machine may comprise a network router, a network switch, a network bridge, a Personal Digital Assistant (PDA), a cellular telephone, a web appliance or any machine capable of executing a sequence of instructions that specify actions to be taken by that machine.

The computer system 500 includes a processor 502, a main memory 504 and a static memory 506, which communicate with each other via a bus 508. The computer system 500 may further include a video display unit 510 (e.g. a liquid crystal display (LCD) or a cathode ray tube (CRT)). The computer system 500 also includes an alphanumeric input device 512 (e.g. a keyboard), a cursor control device 514 (e.g. a mouse), a disk drive unit 516, a signal generation device 518 (e.g. a speaker), and a network interface device 520.

The disk drive unit 516 includes a machine-readable medium 524 on which is stored a set of instructions (i.e. software) 526 embodying any one, or all, of the methodologies described above. The software 526 is also shown to reside, completely or at least partially, within the main memory 504 and/or within the processor 502. The software 526 may further be transmitted or received via the network interface device 520 over the network 530.

It is to be understood that embodiments of this invention may be used as, or to support, software programs executed upon some form of processing core (such as the CPU of a computer) or otherwise implemented or realized upon or within a machine or computer readable medium. A machine readable medium includes any mechanism for storing or transmitting information in a form readable by a machine (e.g. a computer). For example, a machine readable medium includes read-only memory (ROM); random access memory (RAM); magnetic disk storage media; optical storage media; flash memory devices; electrical, optical, acoustical or other form of propagated signals (e.g. carrier waves, infrared signals, digital signals, etc); or any other type of media suitable for storing or transmitting information.

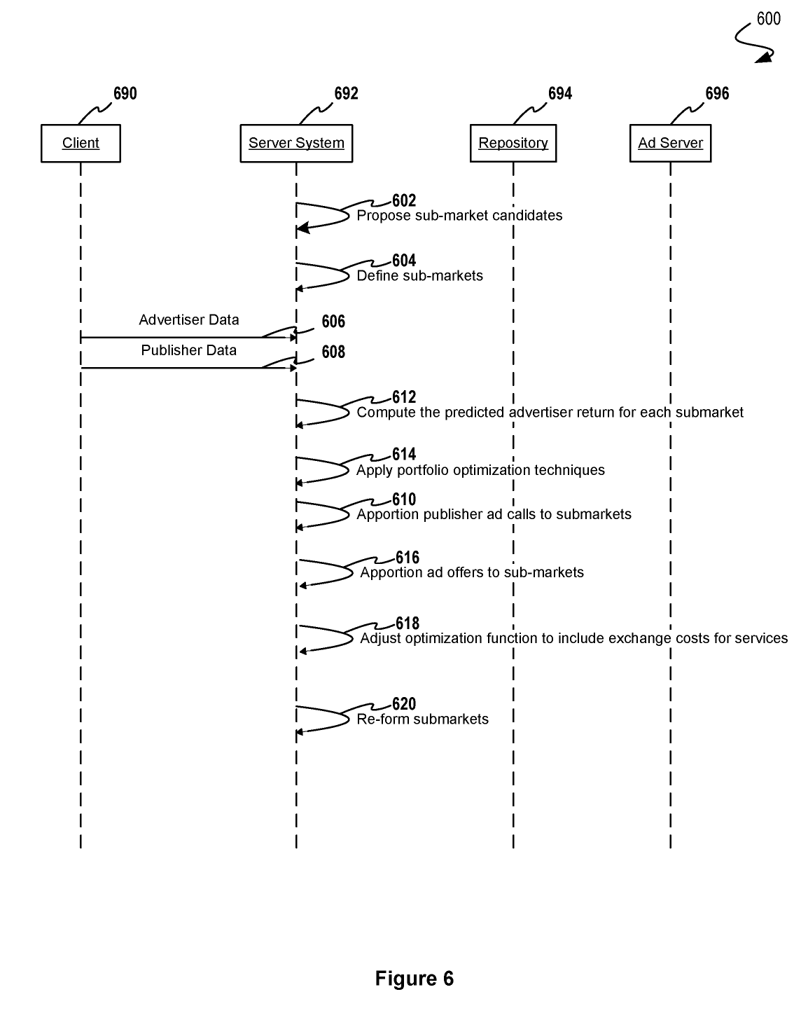

FIG. 6 is a diagrammatic representation of several computer systems (i.e. client, server system, repository, ad server) or their constituent programs (e.g. browser, agent, API, etc) in the exemplary environment of a client server network 600 within which environment a communication protocol may be executed. The embodiment shown is purely exemplary, and might be implemented in the context of one or more of FIG. 1A through FIG. 5. As shown, the server system 692, together with a repository 694, a client 690, and an ad server 696 is operable for carrying out a communication protocol to distribute computation for an exchange that matches advertisement placement opportunities submitted by a publisher to advertisement placement offers submitted by an advertiser. In one embodiment, a server executes operations for forming a plurality of submarkets wherein at least one submarket hosts only a subset of exchange ad placement opportunities, and wherein at least one submarket hosts only a subset of the exchange advertiser placement offers. In particular, operation 602 proposes submarkets, if only by random suggested allocation. The subsequent formation of submarkets might be performed using the aforementioned random allocations to form submarkets, or it might be performed using heuristics to form submarkets, or possibly by using clustering of publishers to form submarkets, or using clustering of offers to form submarkets (see operation 604). Given characteristics of an advertiser, or more specifically characteristics of an advertiser's campaign objectives (see transaction 606), the predicted advertiser return on investment for each submarket can be computed (see operation 612). Similarly, given characteristics of a publisher, or more specifically characteristics of a publisher's Internet properties, (see transaction 608), the publisher's ad calls can be apportioned to the submarkets (see operation 610).

The operation 614 serves for applying a portfolio optimization technique to allocate advertiser offers and budgets over submarkets. In a general case of allocating advertiser offers and budgets over submarkets (see operation 616) by applying a portfolio optimization technique the calculations include computing return on investment by submarket, or if it is deemed that there is insufficient data to compute predicted return on investment, then estimating return on investment for publisher ad calls by submarket. In some embodiments, applying a portfolio optimization technique might include adjusting the portfolio optimization technique (see operation 618) to account for costs to the exchange; for example accounting for the costs to the exchange related to hosting offers on multiple submarkets, or for example accounting for the costs to the exchange related to the exchange services to match ads to ad calls on submarkets. Of course over some time period, the performance of the submarkets might vary (e.g. some submarkets will be measurably more successful that other submarkets), and it might be appropriate to re-form submarkets, and re-apportion resources. Thus, periodically operation 620 executes for the purpose of removing less successful submarkets, and/or replicating more successful submarkets.

While the invention has been described with reference to numerous specific details, one of ordinary skill in the art will recognize that the invention can be embodied in other specific forms without departing from the spirit of the invention. Thus, one of ordinary skill in the art would understand that the invention is not to be limited by the foregoing illustrative details, but rather is to be defined by the appended claims.

We claim:

1. A method to distribute computation for an exchange that matches advertisement placement opportunities submitted by a publisher to advertisement placement offers submitted by an advertiser, comprising:
forming a plurality of submarkets wherein at least one submarket hosts only a subset of exchange advertisement placement opportunities, and wherein at least one submarket hosts only a subset of the exchange advertisement placement offers;
computing the predicted advertiser return on investment for each submarket; and
applying a portfolio optimization technique to allocate advertisement offers and budgets over submarkets.

2. The method of claim 1, further comprising the step of computing predicted publisher return on investment for each submarket.

3. The method of claim 2 wherein the computing predicted publisher return includes at least one of, computing the estimated net present value of exploration, computing the estimated net present values of exploitation, computing the estimated probability of discovering better submarkets through exploration, computing the relative certainty of returns from submarkets.

4. The method of claim 1, wherein the forming a plurality of submarkets includes at least one of, using random allocations to form submarkets, using heuristics to form submarkets, using clustering of publishers to form submarkets, using clustering of offers to form submarkets.

5. The method of claim 1, wherein the applying a portfolio optimization technique includes at least one of, computing return on investment for publisher advertisement calls by submarket, estimating return on investment for publisher advertisement calls by submarket.

6. The method of claim 1, wherein the applying a portfolio optimization technique includes adjusting the portfolio optimization technique to account for costs to the exchange to host offers on submarkets, adjusting the portfolio optimization technique to account for costs to the exchange to match ads to advertisement calls on submarkets.

7. The method of claim 1, wherein the forming a plurality of submarkets includes periodic adjustment of the submarkets by removing less successful submarkets.

8. The method of claim 1, wherein the forming a plurality of submarkets includes periodic adjustment of the submarkets by replicating more successful submarkets.

9. A system to distribute computation for an exchange that matches advertisement placement opportunities submitted by a publisher to advertisement placement offers submitted by an advertiser, comprising:
a module for forming a plurality of submarkets wherein at least one submarket hosts only a subset of exchange advertisement placement opportunities, and wherein at least one submarket hosts only a subset of the exchange advertisement placement offers;
a module for computing predicted advertiser return on investment for each submarket; and
a module for applying a portfolio optimization technique to allocate advertisement offers and budgets over submarkets.

10. The system of claim 9, further comprising a module for computing predicted publisher return on investment for each submarket.

11. The system of claim 10 wherein the computing predicted publisher return includes at least one of, computing the estimated net present value of exploration, computing the estimated net present values of exploitation, computing the estimated probability of discovering better submarkets through exploration, computing the relative certainty of returns from submarkets.

12. The system of claim 9, wherein the forming a plurality of submarkets includes at least one of, using random allocations to form submarkets, using heuristics to form submarkets, using clustering of publishers to form submarkets, using clustering of offers to form submarkets.

13. The system of claim 9, wherein the applying a portfolio optimization technique includes at least one of, computing return on investment for publisher advertisement calls by submarket, estimating return on investment for publisher advertisement calls by submarket.

14. The system of claim 9, wherein the applying a portfolio optimization technique includes adjusting the portfolio optimization technique to account for costs to the exchange to host offers on submarkets, adjusting the portfolio optimization technique to account for costs to the exchange to match ads to advertisement calls on submarkets.

15. The system of claim 9, wherein the forming a plurality of submarkets includes periodic adjustment of the submarkets by removing less successful submarkets.

16. The system of claim 9, wherein the forming a plurality of submarkets includes periodic adjustment of the submarkets by replicating more successful submarkets.

17. A computer readable medium for storing instructions, which when executed by a computer, causes the computer to distribute computation for an exchange that matches advertisement placement opportunities submitted by a publisher to advertisement placement offers submitted by an advertiser, said instructions for:
forming a plurality of submarkets wherein at least one submarket hosts only a subset of exchange advertisement placement opportunities, and wherein at least one submarket hosts only a subset of the exchange advertisement placement offers;
computing the predicted advertiser return on investment for each submarket; and
applying a portfolio optimization technique to allocate advertisement offers and budgets over submarkets.

18. The computer readable medium of claim 17, further comprising instructions for computing predicted publisher return on investment for each submarket.

19. The computer readable medium of claim 18 wherein the instructions for computing predicted publisher return includes at least one of, computing the estimated net present value of exploration, computing the estimated net present values of exploitation, computing the estimated probability of discovering better submarkets through exploration, computing the relative certainty of returns from submarkets.

20. The computer readable medium of claim 17, wherein the instructions for forming a plurality of submarkets includes at least one of, using random allocations to form submarkets, using heuristics to form submarkets, using clustering of publishers to form submarkets, using clustering of offers to form submarkets.
